(19) United States
(12) Patent Application Publication
(10) Pub. No.: US 2005/0271120 A1
(43) Pub. Date: Dec. 8, 2005

(54) Detector for time-hopped impulse radio

(75) Inventor: Ralph T. Hoctor, Saratoga Springs, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: Lockheed Martin Corporation, Bethesda, MD (US)

(21) Appl. No.: 10/858,977

(22) Filed: Jun. 2, 2004

(51) Int. Cl. H04B 1/69

(52) U.S. Cl. 375/138

(57) ABSTRACT

A hostile detector for interception of time-hopped ultra-wide band (TH-UWB) impulse radio transmissions. Synchronization of the hostile detector to the transmitter is not assumed. The detector includes respective parallel matched filters applied to respective time-delayed portions of the TH UWB impulse radio signal. Each time-delayed portion has a duration corresponding to the duration of the pulses. The parallel matched filters provide respective analog output signals. A function selects one of the respective analog output signals that is a maximum among the respective analog output signals. An analog-to-digital converter digitizes the selected one of the respective analog output signals to provide a digitized output signal. A polyphase finite impulse response (FIR) filter is applied to the digitized output signal. A transmission is detected in case the output of the polyphase FIR filter exceeds a decision threshold, which is based on a false alarm rate.

### BACKGROUND OF THE INVENTION

1. Field of Invention

The invention relates generally to a detector for interception of time-hopped impulse radio transmissions.

2. Description of Related Art

Impulse radio is a relatively new approach to radio transmission that promises high data rate along with large multiple access capacity [1,2]. This type of radio is also called ultra-wideband (UWB), because of the high bandwidth of the short impulses that form the carrier of the transmission. The variant of impulse radio that has received the most attention in the literature is called time-hopped UWB (TH-UWB). Other variants of UWB exist and may have some desirable characteristics.

At the present time, it is widely assumed that time-hopped impulse radio has a low probability of detection (LPD) by a receiver other than one for which it was intended; that is, it is hard for a receiver that does not know the hopping code to detect the transmission. This assumption has received some support in the literature [3].

However, it would be desirable to provide a detector for the hostile interception of time-hopped UWB transmissions, which improves upon the performance of previous detectors.

### BRIEF SUMMARY OF THE INVENTION

The present invention describes a hostile detector for interception of time-hopped ultra-wide band (UWB) impulse radio transmissions, and compares its performance to detection by the ideal, intended receiver. The hostile detector does not have the time-hopping code, but we assume it does know the frame duration and number of pulse slots per frame, and that it has a matched-filter for the pulse, just like the intended receiver. Unlike previous work in this area, we have not assumed synchronization of the hostile detector to the friendly transmitter; this assumption has a strong effect on the required false alarm probabilities. The hostile detector of the invention suffers a disadvantage of roughly 6 dB in per-burst SNR with respect to the intended receiver at an SNR operating point determined by systems analysis and desired overall bit error rate. This relatively small disadvantage in E_{b}/N₀ imposes a strict limit on the number of information bits that can be sent in each burst. This, in turn, limits the overall information rate of the link, which is a primary advantage accruing from the use of the present invention. That is, the invention forces the transmitter to transmit at a very low rate if it wants to remain covert. We thus limit the application of the covert radio link to, e.g., a single voice signal. The opponent can stay covert, but the radio link is not very useful.

In a particular aspect of the invention, a detector is provided for a time-hopped ultra-wide band (TH UWB) impulse radio signal in which successive frames are provided, wherein each frame has a frame duration, each frame has a plurality of pulse slots, each of the pulse slots has a pulse slot duration, pulses are provided in the slots to encode information according to a time hopping code, and each of the pulses has a pulse duration. The detector includes means for providing respective analog output signals according to respective time-delayed portions of the TH UWB impulse radio signal. Each of the respective time-delayed portions of the TH UWB impulse radio signal has a duration corresponding to the pulse duration. The detector further includes a select function for selecting one of the respective analog output signals which is a maximum among the respective analog output signals, an analog-to-digital converter for digitizing the selected one of the respective analog output signals to provide a digitized output signal, and a polyphase finite impulse response (FIR) filter applied to the digitized output signal.

The invention may further include a means for detecting a transmission when the output of the polyphase FIR filter exceeds a decision threshold, which may be based on a false alarm rate.

A corresponding method, program storage device, and computer program product may also be provided.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates a structure of a time-hopped impulse radio bit;

FIG. 2a illustrates a receiver operating characteristic (ROC) curve for a friendly receiver;

FIG. 2b illustrates detail of the curve of FIG. 2a for a false alarm probability of 0 to 0.01;

FIG. 3 illustrates the high probability of detection/low probability of false alarm portion of the ROC curves for the ideal matched filter detector;

FIG. 4a illustrates a receiver operating characteristic (ROC) curve for a single pulse detector at low E_{b}/N₀;

FIG. 4b illustrates detail of the curve of FIG. 4a for a false alarm probability of 0 to 0.002;

FIG. 5 illustrates a hostile detector according to the invention;

FIG. 6a illustrates an amplitude versus time plot for an observed TH UWB signal;

FIG. 6b illustrates an amplitude versus time plot for the UWB portion of an observed TH UWB signal;

FIG. 6c illustrates an amplitude versus time plot for the noise portion of an observed TH UWB signal;

FIG. 7a illustrates an amplitude versus time plot for the output of one of the pulse matched filters of FIG. 5, for a friendly receiver that knows the hopping code;

FIG. 7b illustrates an amplitude versus time plot for a gated energy detector receiver output, for a friendly receiver that knows the hopping code;

FIG. 7c illustrates an amplitude versus time plot for a detector with matched filter output, for a hostile receiver that does not know the hopping code;

FIG. 7d illustrates an amplitude versus time plot for a detector output, for a hostile receiver that does not know the hopping code;

FIG. 8a illustrates a receiver operating characteristic (ROC) curve for the detector of FIG. 5 according to the invention;

FIG. 8b illustrates detail of the curve of FIG. 8a for a false alarm probability of 0 to 0.01 according to the invention;

FIG. 9 illustrates a high SNR receiver operating characteristic (ROC) curve for the detector of FIG. 5 according to the invention; and

FIG. 10 illustrates a structure of a burst transmission.

### DETAILED DESCRIPTION OF THE INVENTION

The invention provides a detector for the hostile interception of time-hopped UWB transmissions, which improves upon the performance of previous detectors. The new detector is compared against the intended receiver in terms of its receiver operating characteristic (ROC). We consider the case of a single transmitter, and we assume that the hostile receiver has the same knowledge of the frame time/duration, number of pulse slots and pulse duration as does the intended receiver, but that the hostile party does not know the hopping code and is not synchronized with the transmitter.

Time-Hopped Impulse Radio

In the time hopping scheme, each bit period is divided into a number of frames, all of equal duration. For example, a 10 μsec bit period of a 100 Kbit/sec transmission might be divided into 100 frames of 100 ns each. During each bit period, a single RF pulse is transmitted, and the position of the pulse within the frame encodes part of the transmitted information. The frame is further divided into a number of slots or instants within the frame duration at which the pulse can be transmitted. Typically, a pulse is transmitted in only one slot of each frame. For example, a 100 ns frame might be divided into 10 slots, so that the pulse might be transmitted at the very beginning of a frame, or 10 ns after the beginning, or 20 ns after the beginning, and so on. For the most part, the slot times are set up so that the expected pulse duration at the receiver is less than the slot time, although this is not strictly necessary. If fact, in the indoor channel, a very short transmitted pulse can grow to many times its transmitted duration by the time it reaches the receiver. The duration of the transmitted pulse is typically 1 ns or less. In general, the pulse slot is longer than the pulse so that any ringing or other pulse elongation does not create a situation where a single pulse causes two different matched filters, discussed further below, to respond.

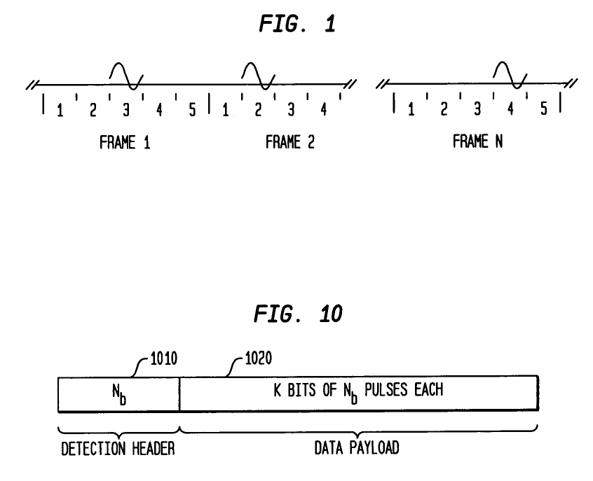

The sequence of slot numbers, one for each frame in the bit, constitutes a code word, called the time hopping code [1]. If two UWB waveforms are synchronized, then it is easy to construct orthogonal waveforms by specifying differing pulse locations in every frame, corresponding to different time-hopping code words. When more that a few waveforms are compared, or when the waveforms are not synchronized, perfect orthogonality cannot be achieved, in general. The structure of a portion of a time-hopped impulse radio code in which there are five slot times per frame is depicted in FIG. 1. In the first frame, the pulse is in slot number three. In the second frame, the pulse occupies slot number two. In the last and Nth frame, the pulse occupies slot number four.

The ideal receiver for the time-hopping scheme includes a matched filter template, composed of a set of matched filters for the individual pulse waveform, spaced in time so that they are applied in a manner that matches the time-hopping code. When the template is time-aligned with the code, all of the matched filters are time-aligned with, and respond to, transmitted pulses. In practice, a matched filter for a short RF pulse may be hard to implement, and the pulse shape itself may be changed radically by passage through a real radio channel. However, even if a matched-filter receiver for impulse radio is not a realistic engineering option, it still provides an optimal performance limit, and so it will be the baseline case considered here. As an alternative to a matched filter, a simple integration over a time period of duration corresponding to the nominal pulse duration may be substituted. In particular, integration of the square or absolute value of the input signal may be performed. Otherwise, the zero-mean pulses will integrate to zero. Any known means for performing integration, such as an integrator, may be used.

The output of the ideal receiver in response to an observed, N-frame, time-hopped impulse radio signal, is given by

$$g ( t ) = {\int }_{0}^{{NT}_{f}} {\sum }_{n = 1}^{N} ( p ( τ - {T}_{n} ) + n ( τ ) ) \times {\sum }_{k = 1}^{N} w ( τ - ( t - {t}_{0} ) - {T}_{k} ) ⅆ τ \qquad ( 1 )$$

where the Tₙ is the delay from the beginning of the code word associated with the pulse in the nth frame to the beginning of that pulse, T_{f} is the duration of the frame, p(t) is the observed pulse waveform, n(t) is additive noise, w(t) is the matched-filter pulse model and to is the difference in time between the beginning of the matched filter window and the onset time of the time-hopped impulse train at the receiver. The sampling instant of the matched filter occurs when t=t₀, at which time the output is

$$\begin{matrix}g ( {t}_{0} ) = {\int }_{0}^{{NT}_{f}} {\sum }_{n = 1}^{N} ( p ( τ - {T}_{n} ) + n ( τ ) ) \times {\sum }_{k = 1}^{N} w ( τ - {T}_{k} ) ⅆ τ \\ = N {\int }_{0}^{{T}_{w}} w ( τ ) p ( τ ) ⅆ τ + {\sum }_{n = 1}^{N} {\int }_{0}^{{T}_{w}} w ( τ ) n ( τ + {T}_{n} ) ⅆ τ\end{matrix} \qquad ( 2 )$$
where T_{w} is the duration of the pulse model, w(t). Now if we assume that the matched filter is accurate, so that p(t)=\sqrt{Eₚ}w(t), and that w(t) has unit energy, then we have

$$g ( {t}_{0} ) = N \sqrt{{E}_{p}} + {\sum }_{n = 1}^{N} {ζ}_{n} \qquad ( 3 )$$
where we have defined ζₙ to be the n^{th} noise variable.

From (2) and (3), and the fact that the signaling scheme is binary and orthogonal, and a knowledge of the statistics of the noise process, a bit error probability can be computed. The bit error probability is conditioned on detection of the RF impulse train and on synchronization to it, that is, estimation of the to parameter. If we assume that the noise, n(t), is a zero-mean white Gaussian process with power spectral density equal to N₀/2, then, using standard matched filter theory [4], ζₙ is mean zero with variance equal to N₀/2. The observation out of the matched-filter template, g(t₀), given by equation (3), is a Gaussian random variable with mean equal to N\sqrt{Eₚ} and variance σₙ²\hat{=}N N₀/2. A standard analysis based on these assumptions [5] yields a bit error probability of

$${P}_{b} = Q ( \sqrt{\frac{N {E}_{p}}{{N}_{0}}} )$$

at the output of the matched filter, where Q(x) is the standard normal tail probability evaluated at x.

In the present context, the bit error probability by itself is of limited interest. We are more interested in the ability of the intended receiver to detect the presence of a burst transmission. We assume that it would do this by applying an N-frame matched filter receiver to its input, and applying a threshold to the receiver's output. Under this assumption, the detection probability can be obtained from (3) using the Neyman-Pearson approach. Given a desired false alarm rate or probability, P_{fa}, the decision threshold is γ=σₙ Q⁻¹(P_{fa}) and the associated probability of detection is

$${P}_{d} = Q ( \frac{γ - N \sqrt{{E}_{p}}}{{σ}_{n}} ) .$$

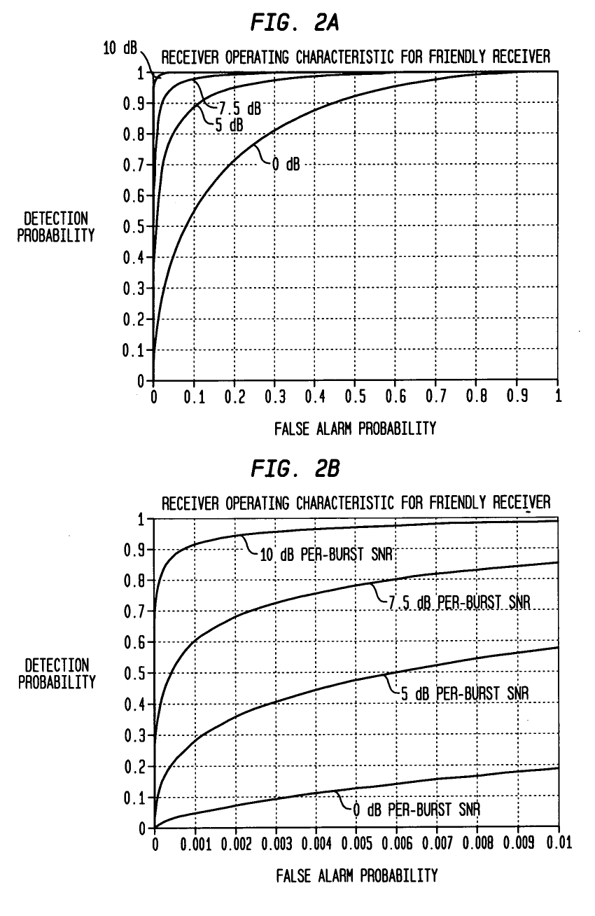

These values can be displayed in the form of a set of receiver operating characteristic (ROC) curves, as shown in FIG. 2a, and in further detail in FIG. 2b for lower false alarm probabilities.

The curves in FIG. 2a and FIG. 2b are parameterized by the per-burst signal-to-noise ratio, φ\hat{=}N Eₚ/N₀, for a burst comprising N pulses. FIG. 2b is simply an expanded view of the low probability of false alarm portion of the whole ROC plot, which is shown in FIG. 2a. The range of P_{fa} in FIG. 2b corresponds to levels that are desirable in a practical detector. Note that a value of φ=10 dB yields probability of detection of just over 0.9 at P_{fa}=10⁻³, while φ=7.5 dB yields P_{d}=0.6 at P_{fa}=10⁻³. From this we might conclude that φ=10 dB (or somewhat higher) is a reasonable operating point for burst detection of impulse radio. However, as we will see, lack of a priori synchronization with the incoming bursts and the requirement for a low bit error rate will force the communications link to the intended receiver to be based on more stringent requirements.

The decision as to what level of P_{fa} to use in a UWB system should be based on the expected cost of a false alarm. For example, in a system where a false alarm caused the demodulation of a large data packet, the validity of which could only be determined by computation of a checksum, a relatively low P_{fa} should be specified. On the other hand, if the burst is very short and if the probability of bit error, conditioned on detection, is very low, so that no bit error control is used, then a lower value of P_{fa} might be called for. If every false detection results in a period of time during which no detection is possible, then the cost of the chosen false alarm rate can be expressed in terms of the proportion of the time the detector is active or on-line, under the noise-only hypothesis.

The required value of the false alarm probability is also affected by the rate at which detections are made. In general, when the detector is not synchronized to the signal it is trying to detect, it has to perform more detections than it would if it were synchronized. For a fixed false alarm probability, a high detection rate raises the expected number of false alarms per unit time. For example, in the current context, if a receiver is already synchronized to the frame clock of the transmitter, then it would only need to perform one detection per frame interval, using a multi-frame matched filter to capture all the energy in a burst. On the other hand, if it were not synchronized, it would need to perform several detections per pulse duration, so as to be sure of having at least one detection for which the matched filters were substantially time-aligned with the received pulses. In a typical system, this would require an increase in the rate at which detections were performed of a factor of roughly 100. In an unsynchronized system, a Pfa of 10⁻³ with 100 detections per frame would result in a false alarm every 10 frame times, on average. If a false alarm triggered a processing event that required hundreds of frame times to resolve (a message burst might require 100 or more frame times) then the receiver would be paralyzed by false alarm processing. Thus unsynchronized detection calls for a low false alarm probability.

In particular, if we assume that a false detection takes the detector off-line for 100 frames, and if we assume 100 detections per frame, and if we require that the detector be on-line for 99% of the time, then the false alarm probability has to be on the order of P_{fa}=10⁻⁶. Note however, that if the detector availability is 99%, and bursts can arrive at any time, then the maximum value that the detection probability can take is 0.99. The effective detection probability is P_{d} times the fractional availability. In the following analysis, we will ignore this penalty for false alarm rate; since this requirement would drive the P_{fa} to be impractically low, we will assume that the system designers will provide a technique to avoid taking the penalty. For example, one such technique would be to provide multiple parallel detection devices.

Additionally, the detection probability of a burst-mode communication system must be determined by the desired bit error rate (BER). If we count all the bits in a missed detection as bit errors, then the overall probability of a bit error is
BER=Pr{bit error|det ection}P_{d}+Pr{bit error|miss}(1−P_{d})=P_{d}P_{d}+(1−P_{d}) (4)
where P_{b} is the bit error probability, conditioned on burst detection and P_{d} is the detection probability. If a desired value of the BER is specified, we can see from (4) that
   P_{d}>1−BER (5a)
   and
   P_{b}<BER (5b)

For example, if P_{d}=0.9999 and P_{b}=0.0009, then BER=10⁻³, which is a reasonable value for voice communications. In contrast, it would require values of P_{d}=0.999999 and P_{b}=0.000009 to achieve a BER of 10⁻⁵, which might be better for telemetry data.

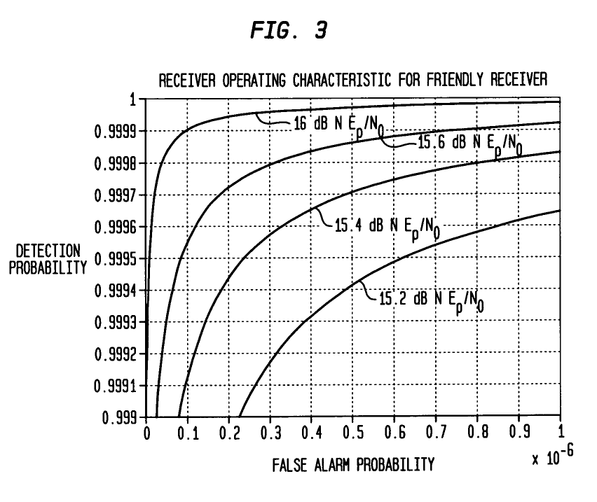

FIG. 3 shows the high probability of detection/low probability of false alarm portion of the ROC curves for the ideal matched filter detector. Here, we can see that a burst SNR of N Eₚ/N₀=16 dB satisfies the requirements for detection at Pd=0.9999. A similar plot, not shown, indicates that it would require a burst SNR of N Eₚ/N₀=17 dB to achieve an over-all BER of 10⁻⁵. In the remainder of this discussion, we will take this as the operating point of the intended receiver. Thus, we are proposing Pd=0.999999 and P_{fa}=10⁻⁷ as (perhaps) workable requirements for an unsynchronized burst mode system supporting a BER of 10⁻⁵.

Single-Pulse Matched-Filter Detector

Hostile detectors for time-hopped UWB have appeared in the literature. In [3], the authors examine a parallel bank of energy detectors, each of which has a window duration equal to the duration of the RF pulse used in the carrier. This bank of energy detectors is taken to be synchronized to the frame clock, so that the individual energy detectors are synchronized to pulse slots. It is clear that this synchronization assumption is entirely unjustified, but the authors claim that they make the assumption in order to establish an upper bound to detectability. The present invention does not assume synchronization to the transmitter. However, as noted above, the lack of synchronization means that a large number of detections per unit time must be employed, which requires a low false alarm probability. While it may be that the cost of a false detection is lower for a hostile detector than for a receiver, there must still be a limit to the allowable number of false alarms per unit time, and so we will require false alarm rate for the hostile detectors that we examine to be as low as those in the intended receiver.

An unsynchronized version of the detector of [3] is equivalent to single radiometer (energy detector) with high output sample rate, and a detection performed on every output sample. As our baseline hostile detector, we will consider a single-pulse matched filter with a high output sample rate. Although it may be more realistic to consider a single radiometer than it is to consider a matched filter, it does not make a crucial difference. The basic point that we are making is that detection based on a single pulse is not tremendously effective, and that this is equivalent to the detector of [3]. The ROC curve of single pulse matched filter detector are the same curves as those shown in FIG. 2a and FIG. 3, except offset by 10 log 10(N) dB. In the single-pulse matched-filter case, the advantage of the friendly receiver over the hostile detector is exactly equal to the length of the hopping code.

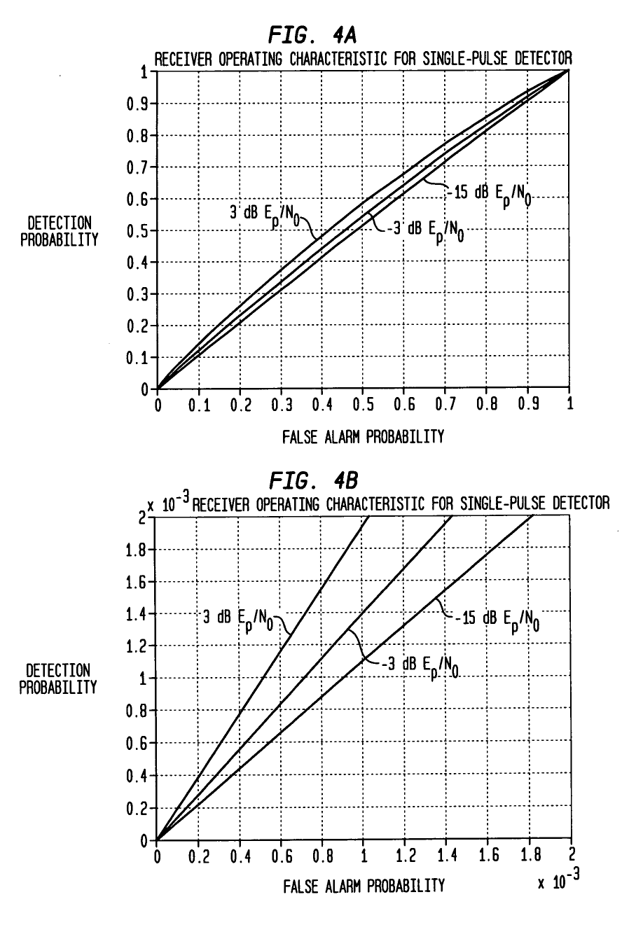

In order to determine a length for the time-hopping sequence, we will take as a requirement that the pulse energy, Eₚ, be low enough to avoid detection of individual pulses by the single-pulse matched filter detector. We will use that pulse energy for which the single-pulse detector yields a detection probability of less than 0.002 at a false alarm rate of 0.001. This specification assures us that the ROC curve for the single-pulse detector is close to the line P_{fa}=P_{d}, which is equivalent to no information. FIG. 4 shows three ROC curves for the single-pulse detector for low SNR. From these plots we can see that a value of Eₚ/Nₒ=3 dB satisfies our criterion. Combining this with our earlier conclusion that N Eₚ/N₀=17 dB, give us a value of N=26.

It is a good sanity check for us to compute the transmitter power required to get us a value of Eₚ/N₀=3 dB at the receiver. Let us guess that the attenuation suffered by the RF pulses will be about the same as the free-space attenuation at the center frequency. We will assume 500 ps pulses and a center frequency of 2 GHz, and we will look at a link over a distance of 1 km. If we assume a receiver noise temperature of 290° K., then we have N₀=−204 dB J, and so Eₚ=−201 dB J. The free-space path loss, using standard formulas [6], is 98.4 dB, so the pulse energy at the transmitter must be −102 dB J. The average power over the pulse duration is then −9.0 dB W (21 dB m), which is roughly 100 milliwatts. Because of the short pulse duration, this is very much like a peak power, and it does not seem hard to implement. Naturally, the average power over the pulse repetition time is much lower.

We have now specified the number of pulses for burst detection and the pulse energy. The last parameter to specify is the number of pulses per information bit. In order to have an over-all bit error rate of 0.00001, we need a probability of bit error, conditioned on detection, of just under 0.00001. With orthogonal signaling, this bit error probability requires E_{b}/N₀=N_{bit} Eₚ/N₀=12 dB. Using Eₚ/N₀=3 dB, N_{bit}=8 or more.

Summary of Impulse Radio Requirements.

To summarize our requirements, we need N Eₚ/N₀=17 dB at the receiver, and we require that N be at least 26 to ensure that the individual pulses are hard to detect with a single-pulse detector. This allows us to have a detection probability of 0.999999 with a false alarm probability of 10⁻⁷. Furthermore, we will signal with N^{bit}=8 pulses per bit to achieve an over-all BER of 0.00001.

We have now introduced the friendly detector/receiver and a simple, if ineffective, single-pulse hostile detector. Next, we will introduce the structure of a new hostile detector, and give an analysis of its probability of detection of a UWB transmission. This is done in Section II. In Section III we analyze an example system and draw conclusions.

II. A Detector for Time-Hopped Impulse Radio

The basic deficiency of the single-pulse hostile detector is that it does not combine all the available energy. If we can arrange to combine energy from all the pulses of a burst, we can increase the hostile detector's detection probability. The problem is how to do this without knowledge of the hopping code.

We assume that the hostile knows the structure of the frame, that is, it knows the duration of the frame and the number and relative times of the pulse slots in the frame. In addition, we assume that the hostile detector has a matched filter for the pulse and that it knows (or has a good guess of) the burst length. We do not assume synchronization. To a certain extent these assumptions are meant to be similar to those of [3], except that we do not require synchronization. The assumptions of [3] were justified by saying that the upper bound on detector performance was desired, but the present work is an attempt to be more realistic than that, so we will make some effort to justify our assumptions further. These assumptions represent restrictions imposed by the scope of the present study, but we feel that the basic conclusions of this study could be made to stand under less restrictive assumptions, by having more elaborate signal processing in the detector.

Knowledge of the frame structure of the transmission by the hostile is quite plausible if a commercial-off-the-shelf (COTS) UWB radio were used for this mission, with parameters modified to give LPD performance with respect to the single-pulse detector. We should also note that we believe that the performance of the detector is not critically dependent on this knowledge.

For an impulse radio, the assumption of having a matched filter is very similar to that of knowing the signal bandwidth. The real problem is in the implementation of such a matched filter, and if the matched filter implementation proves impractical, both the friendly receiver and the hostile detector will be penalized. Since use of the matched filter simplifies the analysis, we have assumed that the receivers have it. However, other designs are possible. For example, as an alternative to a matched filter, a simple integration over a time period of duration corresponding to the nominal pulse duration may be substituted.

It is easy for the designer of a hostile detector to specify a burst length to look for. The burst length is simply that one which gives the desired detection probabilities. If the transmitter uses more pulses than that, they are not needed for detection anyway. If it uses fewer pulses than that, then it is both more covert and has a higher BER at the intended receiver. The hostile force should always operate a single-pulse detector in parallel with the multi-pulse detector described here, in order to force the transmitter to use longer pulse trains.

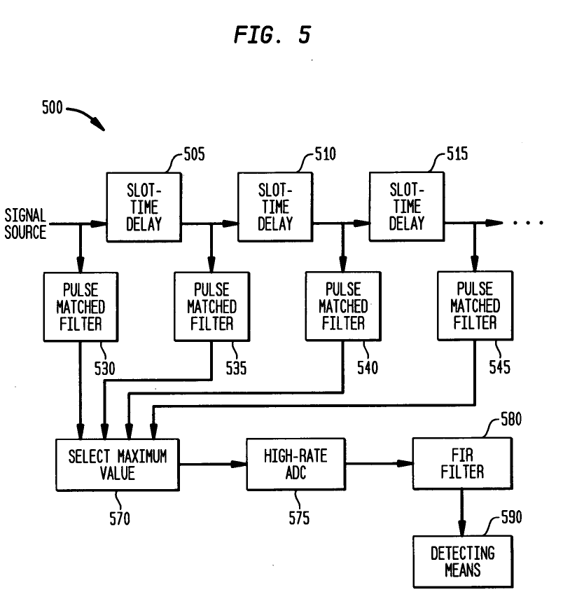

FIG. 5 illustrates a hostile detector according to the invention. It is a detector in which parallel matched filters are applied at points in time separated by the duration of the pulse slot. The detector 500 includes a number of slot-time delay elements or time delay components 505, 510, 515, . . . equal to the number of slots in a single frame. Each delay element delays the signal by one pulse slot duration so that a respective time-delayed portion of the signal is provided to a respective pulse matched filter. In particular, a number of parallel pulse matched filters 530, 535, 540, 545, . . . equal to the number of slots in a frame are provided.

When a frame is time-aligned with the observation window, the output of one of the matched filters is the same as would be seen for this frame in the friendly receiver when the burst was time-aligned with the matched filter template. The outputs of the matched filters 530, 535, 540 . . . are compared in analog, and the maximum value is selected at a maximum select function 570. For signal-to-noise ratios supporting friendly communications, and when the frame is time-aligned, this maximum value has high probability of being that which would be computed by the synchronized friendly receiver. The resulting signal from the maximum select function 570 is digitized at a high-rate analog-to-digital converter (ADC) 575 at a rate that allows for several samples during each pulse time. The resulting digital signal goes into a polyphase finite impulse response (FIR) filter 580. A polyphase FIR filter may be regarded as an ensemble of FIR filters, each sampled at the same, relatively low, sample rate and all offset from each other in time by a fraction of a sample. Each phase of the polyphase filter 580 is sampled at a rate, the period of which is the time between frames. We will take the FIR filter 580 to have a rectangular impulse response of duration equal to the product of the number of frames per burst times the number of phases per frame, thus each separate phase of the filter has a rectangular impulse response of length equal to the expected number of frames in the burst.

The function of the FIR filter 580 is, at a given time, to sum up the outputs recorded for each of some number of the preceding frames from the analog maximum select function 570. The output of the polyphase filter 580 is at a much higher rate than the frame rate however, and it represents many different observed relative time alignments of the input signal and the detector of FIG. 5. When the last frame of a burst of the expected length is time aligned with the input frame window, the output is the sum of the max values of all the matched filter outputs for all the frames in the burst. In the absence of noise, this is identical to the output of the ideal receiver for that burst. As the noise level increases, the probability that the max value actually represents the response of a matched filter to a pulse declines. Naturally, many other samples at the output of the polyphase filter also have relatively high values when a burst is present at the input to the detector. A transmission is detected in case the output of the polyphase FIR filter exceeds a decision threshold, which may be pre-computed. As discussed above, the decision threshold can be based on a desired false alarm rate or probability. Any desired false alarm rate can be used to obtain a decision threshold to use in a practical device. Any type of detecting means 590 for detecting a transmission can be used. For example, the detecting means may compare the output of the polyphase FIR filter 580 to the decision threshold using a comparator. The detecting means 590 may be provided after the FIR filter 580, for instance.

The detector of FIG. 5 may be implemented using any known hardware and/or software components and technologies. The detector 500 may be implemented using a general-purpose computer or dedicated hardware such as ASICs, for instance. A memory resource used for storing instructions, including software, firmware, micro-code or the like, that are executed by a control to achieve the functionality described herein may be considered a program storage device. Such a program storage device may be provided in a manner apparent to those skilled in the art.

In one possible approach, the filter 580 uses a serial configuration in which a FIFO buffer of stored samples from the A/D converter is set up such that every time a new input sample is added to the buffer, an output sample is computed. This can be done using a serial combination of hardware FIFOs to implement the delays of the different phases of the filter 580. For example, if we wanted to add up one sample from each of five frames, we would use four FIFOs, each holding as many samples as there were ADC data samples in a frame time. When a new sample is available, a processor in the filter 580 adds the new sample to the outputs of the four FIFOs, and then writes the new sample into the first FIFO, the output of the first FIFO into the second FIFO, and so on, finally throwing away the output of the last FIFO. In practice, this would have to be done in the reverse order. In this way, the outputs of the FIFOs represent samples taken one frame time ago, two frame times ago, and so on. Implementation of such a device should be apparent to those skilled in the digital hardware design art. The summed output values are compared to a threshold in a serial fashion, in the detecting means 590, and the time alignment of the received frames to the transmitter can be obtained from noting the time at which the threshold is exceeded. The invention thus detects the presence of a UWB transmission without knowing the hopping code.

Note that the invention allows one to determine when a covert TH UWB transmitter is present and is operating. If this is known, and it is further known that the transmission is not from a friendly party, then it can be concluded that enemy forces or sensors are active in the vicinity of the detector. Moreover, although the frame timing is known when the UWB transmitter is detected, the bit timing is not known. Also, we have not assumed that the detector knows how many frames are in a single bit. In general, the energy from many frames is combined to accumulate enough energy for bit detection at the intended receiver. The detector determines the number of frames it will combine by the probability of detection and false alarm rates it wants; in general, this number of frames will constitute more than one transmitted bit, precisely because the intended receiver knows “where to look” and the detector does not.

Furthermore, the received enemy message could be encoded in one of two main ways. Either separate codes words will represent separate bits or groups of bits, or a single code word could be used and the polarity of the pulses might be inverted to represent the two states of a bit. In the latter case, the select function 570 would take the maximum of the absolute values of the outputs of the matched filters 530, 535, 540, 545. The absolute value can be calculated, e.g., at the matched filters 530, 535, 540, 545, . . . , at the select function 570, or an intermediate location. Thus, the respective analog output signals output from the respective matched filters 530, 535, 540, 545, . . . may be the values before or after the absolute value is taken.

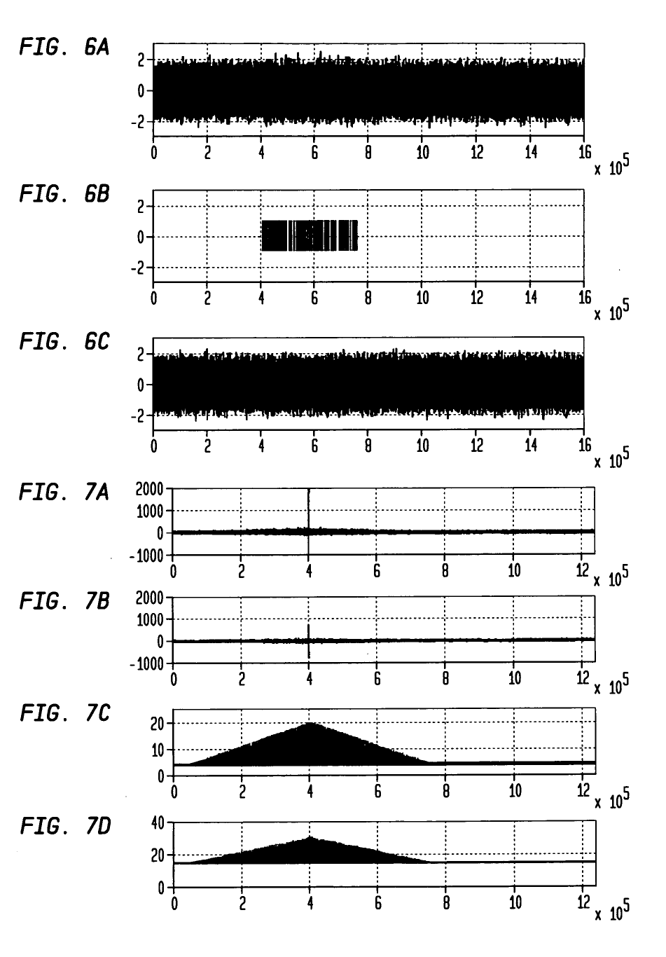

Simulation results for the detector 500 are shown in FIGS. 6a-6c and 7a-7d. In particular, FIG. 6a depicts the observed signal, FIG. 6b depicts its UWB impulse radio parts, and FIG. 6c depicts the observed signal's component noise. FIGS. 7a and 7b depict the action of a friendly receiver that knows the hopping code, both with (FIG. 7a) and without (FIG. 7b) a pulse-matched filter, operating on the signal of FIG. 6a. FIGS. 7c and 7d depict the output of the hostile detector of FIG. 5, both with (FIG. 7c) and without (FIG. 7d) a pulse-matched filter, operating on the signal of FIG. 6a. The presence of the burst can be output waveform of FIG. 7c or of FIG. 7d.

Analysis of the performance of the detector of FIG. 5 may proceed as follows. The distribution of the output under the noise-only hypothesis is easy to obtain; the distribution of the maximum value of an independent, identically distributed sample of size K, with pdf f(x) and cdf F(x) is K f(x) [1−F(x)]^{K-1} [7]. Note that if f(x) is the pdf of a zero-mean random variable, the pdf of the max will have nonzero mean value, and that the pdf of the output of the matched filter under the noise hypothesis is Gaussian with mean zero and variance N₀/2. When a large number of random variables with the distribution K f(x) [1−F(x)]^{K-1} are summed (in the FIR filter discussed above), the result is Gaussian with mean and variance related to the mean and variance of the output of the maximum value selector. For a given noise distribution, the mean and variance can be obtained by numerical integration.

Under the signal plus noise hypothesis, the samples out of the matched filters are not iid, although the Central Limit Theorem (CLT) can still be used to claim that the output of the FIR filter is Gaussian. Since we do not need the actual pdf of the max of the non-iid sample, but rather only its mean and variance, we have obtained these by Monte Carlo simulation, rather than by analysis.

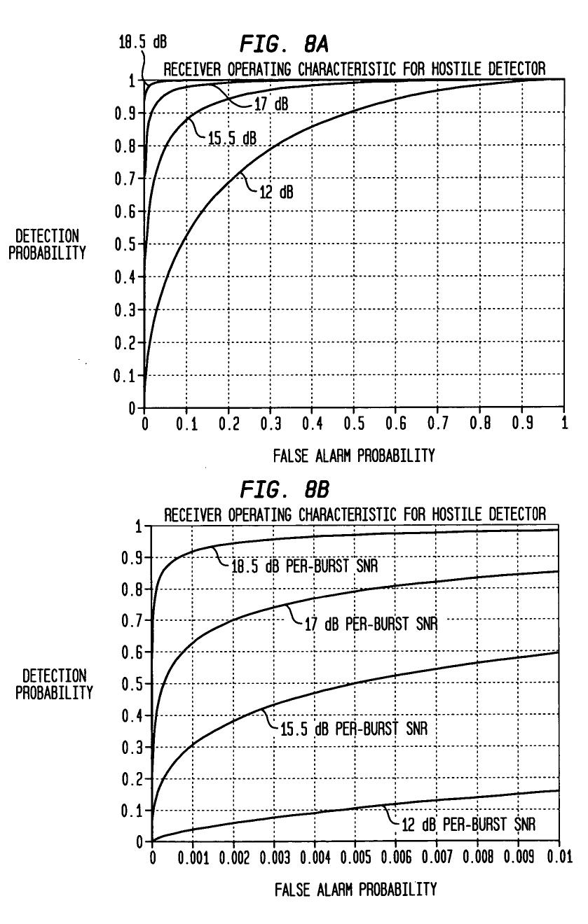

We used the numerical methods outlined above to compute the ROC curves of FIG. 8a and FIG. 8b. These plots are to be compared with those in FIG. 2a and FIG. 2b, respectively. Note the loss of about 8-10 dB compared to coherent matched filter receiver. It is also apparent that the disadvantage relative to the ideal receiver decreases with increasing SNR. This effect is not unexpected, since at high SNR the maximum of each sample of matched filter outputs is increasingly likely to be determined by the presence of a pulse; at high SNR the ROC curves of the hostile detector and the ideal receiver are nearly identical.

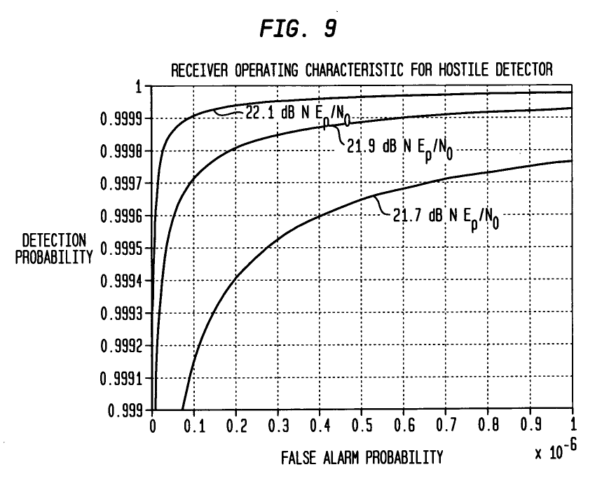

FIG. 9 shows ROC curves for the hostile detector in the same range of detection performance as is depicted for the ideal receiver in FIG. 3. Comparison of FIG. 9 and FIG. 3 shows that the performance of the ideal receiver at N Eₚ/N₀=16 dB can be obtained with the hostile detector at only N Eₚ/N₀=22.1 dB. This is a loss of only 6.1 dB, corresponding to a factor of four in the number of pulses (or frames) required to produce this level of performance. Since we have taken our required SNR operating point to be equal to N Eₚ/N₀=17 dB, we can see that the hostile detector can duplicate the performance of the ideal receiver with only four times as many pulses, at the specified operating point.

The losses in the detector of FIG. 5 are the same for all burst sizes, assuming that the ideal detector has the same burst size. The transmitter can defeat the detector of [3] and the single-pulse detector of Section I by sending a long code with a low value of Eₚ, but the performance of the detector of FIG. 5 is based on N Eₚ/N₀, so that low burst energy is required. This is a very important improvement, in that it restricts the transmitter to burst mode operation, since in continuous operation, the “burst energy” can be made as large as desired at the receiver by lengthening the observation window.

### III. EXAMPLE AND CONCLUSIONS

In a burst mode communications system, the intended receiver must detect the burst on the basis of a detection preamble/header 1010 (FIG. 10), and the remainder of the burst must consist of a data payload 1020. The structure of the burst is depicted in FIG. 10. The hostile detector, on the other hand, can use the entire burst for detection. This means that friendly receiver detects with N=Nₚ pulses, while hostile uses (Nₚ+K N_{b}), where K is the number of bits in the message portion of the burst. This limits the size of the payload relative to the header. In the last section we noted that the hostile detector has a disadvantage of about N Eₚ/N₀=6.1 dB with respect to the friendly receiver, for a fixed burst size and at the operating SNR level derived in Section I. This means that the hostile detector can approximate the detection performance of the friendly if it sees roughly four times as many frames. Thus the hostile detection performance is only worse than the friendly detection performance for

$$\begin{matrix}{N}_{p} > \frac{( {N}_{p} + K {N}_{b} )}{4} \\ or \\ \frac{3 {N}_{p}}{{N}_{b}} > K .\end{matrix}$$

In the baseline system that we proposed in Section I, Nₚ=26, and N_{b}=8, so that

$$\frac{3 \times 26}{8} = 9.75 > K$$

This is to be interpreted as saying that the number of information bits in each burst must be nine or fewer if the receiver BER and single-pulse covertness requirements are to be met. If we take a typical frame time of 100 ns, and 9 bits per burst, then the duration of a burst is 9.8 μs. If we take the burst duty cycle to be 50-to-1 (one burst for every 50 burst times, on average), then the overall data rate supported would be just over 2 kbits/sec. This could be increased by changing the duty cycle, to a maximum of 102 kbits/sec at a 1-to-1 duty cycle, but such a high duty cycle would have the effect of making hostile detection very much more likely.

### REFERENCES

[1] M. Z. Win and R. A. Scholtz, “Ultra-wide bandwidth time-hopping spread-spectrum impulse radio for wireless multiple-access communications,” IEEE Transactions on Communications, vol. 48, pp. 679-691, April 2000.
[2] M. Z. Win and R. A. Sholtz, “Impulse radio: how it works,” IEEE Communications Letters, vol. 2, pp. 36-38, February 1998.
[3] A. Bharadwaj and J. K. Townsend, “Evaluation of the covertness of time-hopping impulse radio using a multi-radiometer detection system,” Proc. IEEE Military Communications Conference, 2001, vol 1, pp. 128-134, McLean, V A, October 2001.
[4] J. V. DiFranco and W. L. Rubin, Radar Detection, Artech House, 1980.
[5] J. G. Proakis, Digital Communications, 3d Ed., McGraw-Hill, 1995.
[6] S. R. Saunders, Antennas and Propagation for Wireless Communication Systems, John Wiley and Sons, 1999.
[7] V. K. Rohatgi, An Introduction to Probability Theory and Mathematical Statistics, John Wiley and Sons, 1976.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

1. A detector for a time-hopped ultra-wide band (TH UWB) impulse radio signal in which successive frames are provided, wherein each frame has a frame duration, each frame has a plurality of pulse slots, each of the pulse slots has a pulse slot duration, pulses are provided in the slots to encode information according to a time hopping code, and each of the pulses has a pulse duration, comprising:
means for providing respective analog output signals according to respective time-delayed portions of the TH UWB impulse radio signal;
each of the respective time-delayed portions of the TH UWB impulse radio signal having a duration corresponding to the pulse duration;
a select function for selecting one of the respective analog output signals which is a maximum among the respective analog output signals;
an analog-to-digital converter for digitizing the selected one of the respective analog output signals to provide a digitized output signal; and
a polyphase finite impulse response (FIR) filter applied to the digitized output signal.

2. The detector of claim 1, wherein:
the means for providing the respective analog output signals comprises a plurality of respective parallel matched filters applied to the respective time-delayed portions of the TH UWB impulse radio signal.

3. The detector of claim 1, wherein:
the means for providing the respective analog output signals comprises means for performing an integration, over the pulse duration, of the square or absolute value of the respective time-delayed portions of the TH UWB impulse radio signal.

4. The detector of claim 1, further comprising:
time delay components for delaying the TH UWB impulse radio signal by increments of the pulse slot duration to provide the respective time-delayed portions of the TH UWB impulse radio signal.

5. The detector of claim 1, wherein:
the analog-to-digital converter digitizes the selected one of the respective analog output signals at a rate which allows for several samples during each pulse duration.

6. The detector of claim 1, wherein:
each phase of the polyphase FIR filter is sampled at a rate, the period of which is the frame duration.

7. The detector of claim 1, wherein:
the polyphase FIR filter has a rectangular impulse response of duration equal to a product of: (a) a number of frames per burst in the TH UWB impulse radio signal and (b) a number of phases of the polyphase FIR filter.

8. The detector of claim 1, wherein:
each separate phase of the polyphase FIR filter has a rectangular impulse response of length equal to an expected number of frames per burst in the TH UWB impulse radio signal.

9. The detector of claim 1, wherein:
the detector is a hostile detector that is unsynchronized with a transmitter of the TH UWB impulse radio signal.

10. The detector of claim 1, further comprising:
means for detecting a transmission when an output of the polyphase FIR filter exceeds a decision threshold.

11. The detector of claim 10, wherein:
the decision threshold is based on a false alarm rate.

12. A method for detecting a time-hopped ultra-wide band (TH UWB) impulse radio signal in which successive frames are provided, wherein each frame has a frame duration, each frame has a plurality of pulse slots, each of the pulse slots has a pulse slot duration, pulses are provided in the slots to encode information according to a time hopping code, and each of the pulses has a pulse duration, comprising:
providing respective analog output signals according to respective time-delayed portions of the TH UWB impulse radio signal;
each of the respective time-delayed portions of the TH UWB impulse radio signal having a duration corresponding to the pulse duration;
selecting one of the respective analog output signals which is a maximum among the respective analog output signals;
digitizing the selected one of the respective analog output signals to provide a digitized output signal; and
applying a polyphase finite impulse response (FIR) filter to the digitized output signal.

13. The method of claim 12, wherein:
the providing the respective analog output signals comprises filtering the respective time-delayed portions of the TH UWB impulse radio signal using a plurality of respective parallel matched filters.

14. The method of claim 12, wherein:
the providing the respective analog output signals comprises performing an integration, over the pulse duration, of the square or absolute value of the respective time-delayed portions of the TH UWB impulse radio signal.

15. The method of claim 12, further comprising:
delaying the TH UWB impulse radio signal by increments of the pulse slot duration to provide the respective time-delayed portions of the TH UWB impulse radio signal.

16. The method of claim 12, wherein:
the digitizing comprises digitizing the selected one of the respective analog output signals at a rate which allows for several samples during each pulse duration.

17. The method of claim 12, wherein:
the applying comprises sampling each phase of the polyphase FIR filter at a rate, the period of which is the frame duration.

18. The method of claim 12, further comprising:
detecting a transmission when an output of the polyphase FIR filter exceeds a decision threshold.

19. The method of claim 18, wherein:
the decision threshold is based on a false alarm rate.

20. At least one program storage device encoded with instructions for performing the method steps of the method of claim 12.
